(19) United States
(12) Patent Application Publication
(10) Pub. No.: US 2025/0242280 A1
(43) Pub. Date: Jul. 31, 2025

(54) EMULSION FOAM REDUCER FOR WET PROCESSING OF CELLULOSE OR WOOD-BASED PRODUCTS OR IN FOOD PROCESSING

(71) Applicant: STATE LINE HOLDINGS, LLC, Ridgeway, VA (US)

(72) Inventors: Joseph W. HUNDLEY, Martinsville, VA (US); Steven A. DUNWOODY, Castle Hayne, NC (US); David M. HUNDLEY, Ridgeway, VA (US)

(21) Appl. No.: 19/071,023

(22) Filed: Mar. 5, 2025

Related U.S. Application Data
(62) Division of application No. 17/171,689, filed on Feb. 9, 2021.
Application No. 17/171,689 is a continuation of application No. 15/551,831, filed on Dec. 20, 2017, now Pat. No. 10,933,352.
(60) Provisional application No. 62/117,934, filed on Feb. 18, 2015.

(51) Int. Cl. B01D 19/04; A23L 27/00; A23L 29/10; D21H 17/00; D21H 17/02; D21H 17/04; D21H 17/06; D21H 17/14; D21H 17/60; D21H 17/64; D21H 21/12; D21H 21/20; D21H 27/18

(52) U.S. Cl. CPC B01D 19/0404; A23L 27/80; A23L 29/10; B01D 19/04; B01D 19/0413; D21H 17/02; D21H 17/04; D21H 17/06; D21H 17/14; D21H 17/60; D21H 17/64; D21H 17/72; D21H 17/74; D21H 21/12; D21H 21/20; D21H 27/18; A23V 2002/00

(57) ABSTRACT

Methods are provided for defoaming water used in processing of various products such as cellulose or wood-based products or in food processing which is formed by reacting a fatty acid with a compound selected from the group consisting of ammonia, sodium, potassium and combinations thereof so as to form a water soluble soap, dispersing the water soluble soap in water and homogenizing the dispersed water soluble soap with hydrophobic oil or hydrocarbon oil to produce the emulsion. Methods for preparing an emulsion used in this process are also provided. The emulsion is advantageous in that it can improve water resistance and/or reduce the use of water resistant additives during processing of cellulose or wood-based products or food-grade products.

### CROSS-REFERENCE TO RELATED APPLICATIONS

This application is a divisional application of U.S. application Ser. No. 17/171,689, filed Feb. 9, 2021, which was a continuation of U.S. application Ser. No. 15/551,831, having a filing date of Dec. 20, 2017, which was a National Stage application of International Application No. PCT/US2016/018431, filed Feb. 18, 2016, and also claims the benefit of U.S. Provisional Application Ser. No. 62/117,934, filed Feb. 18, 2015, all of said applications being incorporated in their entirety herein by reference.

### FIELD OF THE INVENTION

The present invention relates in general to a method of reducing foam and entrained air in industrial water processes with an efficient and low cost defoamer/antifoaming agent. The present invention can also contribute to improved water resistance or reduced use of water resistant additives when used in wet process cellulose or wood based products. The invention can also be used in food processing, in particular for treatments employing alum (aluminum sulfate) and other similar compounds, e.g., in pickle processing.

### BACKGROUND OF THE INVENTION

Foam and entrained air are problems that affect processing efficiency and product quality in a number of industries. These industries can include manufacturing processes for food grade products as well as manufacturing processes for pulp and paper products. Foam and entrained air are particular costly problems within the pulp and paper industries. Foam and entrained air reduces efficiency and impacts surface quality of paper, paperboard and other wet process wood based products. Water based foam is usually destabilized by reducing the surface tension of the bubbles or by introducing a finely divided solid which are water insoluble or hydrophobic. These small particles, when in contact with the bubble, thin the bubble at the point of contact and causes bubble to pop. Some of the water insoluble solids used are fatty acids reacted with metals like aluminum, calcium, magnesium, iron, and zinc. Calcium stearate, magnesium stearate, iron stearate, aluminum stearate and zinc stearate are all used. Non polar oils, solvents, or liquid hydrocarbons that contribute to the destabilization of the bubble may be used to disperse the insoluble solid. This dispersion may be used as is or emulsified. One of the problems with some current defoaming emulsions is the emulsion has to have a sufficiently high viscosity to keep hydrophobic particles suspended. This can cause difficulty in pumping, particularly if some of the suspended particles settle out.

Another issue is the soaps used to make these defoamer emulsions have a negative effect on the level of water resistance produced in fiberboard, hardboard and cellulose based products made with the wet process. Defoamers that are not an emulsion also may have a negative impact on the level of water resistance produced due to inclusion of wetting agents and detergents. Building codes require a minimum level of water resistance as a required specification for manufactured board. If manufactured board does not have a sufficient water resistance property it will swell, change dimensions, degrade and can be expensive to replace in a building. In the manufacture of cellulose board products made with the wet process, the level of water resistance is a key specification for board used in the building industry. Water resistance is a measure of how much water will soak into the wood based product under controlled conditions usually tested by submerging in water for 2 hours or 24 hours. High water absorption in manufactured board causes board to grow in dimensions, lose strength, and degrade when exposed to moisture. The water resistance test standard is further described in ASTM C-209.

The present invention overcomes problems of high viscosity and the negative impact of the detergents and wetting agents on level of water resistance when used in wet processes with hardness or aluminum ions.

This present invention centers on using a foaming agent to emulsify non-polar compounds such as but not limited to oils and waxes to produce a defoaming agent. In water based systems which have foam and contain sufficient ions of calcium, magnesium, iron, aluminum, or zinc, the new defoamer in the present invention works without the addition hydrophobic insoluble particles. Instead of adding these particles, the particles are formed by the fatty acid soap reacting with the previous listed ions. The addition of non-polar oils, fats, wax, solvents and blends thereof to form emulsion improves the effectiveness of the defoamer. The foaming agent is selected from water soluble fatty acids soaps which react with soluble metals, anions and cations in the industrial water, to form an insoluble hydrophobic particle. These newly formed particles then pop bubbles when they come in contact with bubbles. Liquid hydrocarbon and nonpolar solvents or fuels have been used as defoamers both as a liquid and in emulsion form. Including these hydrocarbons into this soap based emulsion makes an effective defoamer. By selecting food grade components, it can be used in systems that require food grade defoamers. The present invention produces an emulsion which does not require high viscosity to suspend solids and the formulation does not include detergents or wetting agents which may negatively impact the water resistance performance of the final product.

Another embodiment of the present invention centers on formulating the emulsion to use as a product for adding to the process water or to the head box in the production process of fiberboard, hardboard, and cellulose based products made with an aqueous process in order to produce a water resistance attribute of the final product as well as act as a defoamer product. In water based systems which contain sufficient ions of calcium, magnesium, iron, aluminum, or zinc, the new emulsion in this embodiment of the present invention works by the fatty acid soap reacting with the previous listed ions in a similar manner as the defoamer product. The non-polar oils, fats, wax, solvents and blends thereof to form the emulsion create the water resistant properties in the final product.

Volatile hydrocarbons can create opacity conditions in manufacturing processes where a heat treatment, drying or curing process step is employed. This opacity condition will limit process line speeds and limits production rates driving up costs.

Using fewer hydrocarbons reduces emissions potential. Using an emulsion helps conserve natural resources by reducing the percentage of hydrocarbon and replacing with water. In processes where a manufactured board is produced, the board is pressed or dried at an elevated temperature. The higher the temperature is the more important selecting low volatile materials becomes. High volatile materials contribute to opacity and smoke and can cause manufacturing plants to exceed emission limits. This can limit production and productivity if not addressed with raw material selection. In processes where volatility is an issue such as a heat treatment, drying or curing process, less volatile non polar oil, solvents, and blends of waxes may be used. This may be done to reduce emissions such as smoke or VOC's; the temperature and process condition of the heat treatment, drying or curing process help determine which non polar additives can be used.

In processes where low volatility and water resistance attribute of the final product are both important, non-polar waxes may be used. The carbon chain distribution of the waxes can be used to help select which waxes would smoke more and which waxes will smoke less during the heat treatment, drying or curing process step. Waxes with a higher percentage of chain length in the C20 to C26 will generally smoke more than a wax with a lower percentage in the C20 to C26 range. The flash point, normal paraffin content and oil content may be useful in selecting which waxes to use or test. A simple mass loss test where weighed samples of waxes are heated to process temperature and held in an oven for an hour then reweighed to determine percentage of wax vaporized is useful in selecting the best wax as far as volatility.

The carbon chain distribution analysis can also be used to predict which wax would impart the best level of water resistance. For low volatile waxes, waxes with a higher percentage of C29 to C36 would be expected to create a higher level of water resistance than a wax with a lower percentage in the C29 to C36 range and with a higher percentage greater than C40. The normal paraffin content also plays a role in creating water resistance where straight chain (normal paraffin) create a higher level of water resistance than branched and cyclic paraffin.

In processes where volatility is not an issue waxes with higher percentage of chain length in the C24 to C30 would be expected to produce a good level of water resistance and defoamer properties.

Wax emulsions made with fatty acids reacted with ammonia exhibit defoaming properties and water resistant properties and work effectively with process water which contains hardness or aluminum ions. Reduction in the pounds of wax used in some applications has been greater than 20 percent and the need for a separate defoamer reduced or eliminated. Using less wax will also reduce emissions if any of the wax is volatilized during processing.

The addition of finely divided hydrophobic insoluble solids may be helpful in systems that do not contain enough ions that form a hydrophobic insoluble solid when reacted with the water soluble soap. Masking agents may be added to give a pleasing smell.

Viscosity modifiers may be added to increase or decrease viscosity. The addition of solids builder like clays may also be added to the emulsion to impart properties and to lower cost. Additional emulsifiers may be added to improve stability as long as they do not interfere with exchange reaction or cause a decrease in water resistance.

### SUMMARY OF THE INVENTION

In accordance with the present invention, composition and methods are provided to produce and introduce a defoaming agent into industrial process water, food products that contain alum, as well as waste streams. The method contemplates producing a foaming agent, adding non polar oil and emulsifying thus producing a defoaming agent, adding defoaming agent to industrial water at a point for maximum foam control. Maximum effectiveness is dependent on hardness of water where ions of calcium, magnesium, iron, aluminum, or zinc (hardness) is present in sufficient concentration for an exchange reaction to take place. An example of this exchange reaction in a water solution is as follows:

Water Soluble Soap+Water Soluble Metal Salt=Soluble Salt+Insoluble Organometallic Solid, for example:

Ammonium Stearate+Aluminum Sulfate yields Ammonium Sulfate and Aluminum Stearate

In this example Aluminum Stearate is formed which is a water insoluble solid capable of disrupting the bubble film and causing bubble to pop. Aluminum Stearate is hydrophobic and can contribute to improved level of water resistance in wood based products.

The Ammonium Stearate will react in a similar way with ions of Magnesium, Calcium, Iron, and Zinc to form Magnesium Stearate, Calcium Stearate, Iron Stearate, and Zinc Stearate which are water insoluble and solids.

Although the preferred Fatty Acid is reacted with Ammonium hydroxide to form Ammonium Stearate other water soluble Stearate soaps may be used or made.

Examples are Sodium Stearate made from Stearic Acid and Sodium Hydroxide, Potassium Stearate made from Stearic Acid and Potassium Hydroxide or of combination of ammonium, sodium or potassium stearate or fatty acids. The great advantage of this new defoamer emulsion is when the soap in the emulsion reacts with the ions it no longer acts as soap. No longer functioning as soap helps improve the level of water resistance in a manufactured board product. This is a valuable attribute of the wet process manufactured board industry. The level of water resistance is one of the key specifications that must be met. Adding most soaps reduces the level of water resistance and is usually overcome by adding more wax or some other water resistance additive.

In the above examples Stearic Acid is used. Other fatty Acids may be substituted in place of the Stearic Acid as long as they can form water soluble soap, and undergo an exchange reaction with Aluminum, Magnesium, Calcium, Iron or Zinc and form an insoluble solid.

In addition to the fatty acid Stearic Acid, other fatty acids may be used to react with ammonia, sodium, and potassium to form water soluble soap among these are the saturated fatty acids Caprylic, Capric, Lauric, Myristic, Palmitic, Arachidic, Behenic, Lignoceric and Cerotic. Unsaturated Fatty Acids will also form water soluble soaps when reacted with Ammonia, Potassium and Sodium. The unsaturated Fatty Acids Myristic, Palmitoleic, Sepienic, Oleic, Elaidic Vaccennic, Linoleic, Linolaidic, Arachidonic, Eicosapentaenoic, Erucic, Docosahexexaenoic, Tall oil, and mixtures thereof may be used to form a water soluble soap. These soaps will not improve the level of water resistance until they react with ions of aluminum, calcium, magnesium, iron or zinc. Other metal ions will also react with this fatty acid soap to form a water insoluble particle. It is expected that the presence of ions of lead, copper, cadmium, and other heavy metals will also be effective in forming the hydrophobic particles needed to pop bubbles.

The Fatty Acid may be selected from both the saturated and unsaturated and contain either a single fatty acid or a combination of two or more fatty acids.

Additionally the fatty acid may be reacted with Ammonia, Sodium, or Potassium or a combination of Ammonia, Sodium, or Potassium. Emulsions made with fatty acids reacted with ammonia exhibit lower viscosity and increased stability over both potassium and sodium. With regard to pH, a range of pH may be used in the process, such as pH 5 or higher, or in the range of pH 6 to 9, but in general, the more basic the ingredients are, the better the stability of the process. For example, a pH of 8 is more stable than a pH of 7, a pH of 9 is more stable than a pH of 8, and a pH of 10 is more stable than a pH of 9. In general, although pH can be in the range of 6 to 9, the preferred pH for the most stabile emulsion is a pH of 9 or above, and more preferably, 10 or above. While the lower pH's can be used in the present process, it has generally been found that the stability increases as the pH is increased in emulsion. Decreasing the solids content and increasing the fatty acid content can also increase the stability of the emulsion.

The non-polar hydrocarbon may be selected from any hydrocarbon oil, wax or solvent. Some examples of non-polar hydrocarbon are vegetable oil, biodiesel, methyl ester, mineral oil, paraffin oil, paraffin wax, kerosene, diesel, and mineral spirits or other non-polar solvent or oil, or combinations thereof. The selection of non-polar hydrocarbon should be selected based on process and processing conditions. The process temperatures as well as environmental control like a thermal oxidation unit are used to select the non-polar hydrocarbon. Non-polar hydrocarbons with short chain lengths are more volatile than long chain length hydrocarbon thus long chain length hydrocarbons would be used when volatility is an issue. Most commercial grade waxes are blends of many different chain lengths and structure.

Selecting the best waxes depends on process conditions. A manufactured board process that dry's board at 350 degrees F. can use a wax that would be too volatile for a process that dry's board at 550 degrees F.

During the process of developing a high solids wax emulsion with a viscosity less than 200 centipoise, the following relationships were discovered: The solids content could be increased as the fatty acid content was reduced. The solids content could be increased as the pH was increased. The solids content could be increased by increasing the particle size. Shear stability and stratification could be improved by lowering the solids content increasing fatty acid content, and decreasing the particle size. Soft water generally is used to make the emulsions. Small amounts of hardness in the water used to make the emulsion, was observed as having very little effect on emulsion.

During the development of a defoamer using bio diesel, the soap solution was tested as a defoamer without any non-polar hydrocarbon added to the soap solution.

The soap solution was determined not to be effective as a defoamer when used alone. The bio diesel was tested by itself and found it did not break foam as quick as the emulsion with the ammonium soap and bio diesel. This new emulsion defoamer was more effective as defoamer, lower in cost and contributing to lower emissions during drying of wood based products.

Water resistant additive and method for improved water resistance in manufactured board or wood products. Method includes manufacturing emulsion and applying to wood or to process to achieve improved water resistance and in some cases less foam in wet process systems. Emulsion consists of water, Fatty acid, ammonia, and paraffin wax or oil and blends thereof; a method of imparting water resistance to manufactured board, paperboard or other wood based products. Method includes manufacturing emulsion consisting of water, paraffin wax or paraffin oil and combinations thereof, ammonia stearate or other ammonia fatty acid soap, Method includes adding or making hot water solution of ammonia fatty acid soap, then adding paraffin wax or paraffin oil or combinations thereof to hot soap solution and mixing and homogenizing until particle size is reduced sufficiently to produce stable emulsion: Adding emulsion to manufactured board, paperboard or other wood based product in a manner to evenly distribute emulsion in process or with the wood or wood fiber or pulp; method includes soap portion undergoing an exchange reaction, where the soap is no longer a soap, but is a water resistant compound; Method includes drying or pressing to produce the finished product.

A method is provided for making insulation board, hardboard, paperboard, and other products made with the wet process paper process; said method including refining wood or wood chip into fiber adding binder, flocculants like aluminum sulfate, and adding wax emulsion consisting of blends of paraffin wax and/or paraffin oil, Fatty acid soap neutralized with ammonia, like ammonium stearate. The method includes adding emulsion to process water in a manner to evenly distribute wax emulsion and to allow for the fatty acid soap to react with the aluminum from the aluminum sulfate or hardness ions to form water resistant additive like aluminum stearate thus changing soap in the emulsion into water resistant additive and contributing to defoamer properties. The method of the invention allows for reduced wax usage or improved water resistant properties in the final product while reducing foam; method includes the drying and in some cases the pressing steps to make final product.

This present invention overcomes many of the deficiencies of defoamers used in wet process systems by reacting with hardness ions. The soap in the present invention is no longer soap after reacting with process water. Thus it does not interfere with water resistance, but contributes to improved water resistance. One embodiment can be made entirely of sustainable plant or animal based hydrocarbons. Another embodiment, low volatile hydrocarbons can be selected to reduce air emissions, while imparting water resistance. In some cases a 20-35 percent reduction in water resistant additive has been achieved while maintaining water resistant properties. When the same hydrocarbon is used in a different formulation, the present invention will generate less air emissions by virtue of using less hydrocarbon material.

### DETAILED DESCRIPTION OF THE INVENTION

### Testing of Defoamer:

Defoamer effectiveness was determined by the following method: Fill quart jar half full with water with foam issue. Put on jar lid and shake vigorously. Note foam generated and add one drop of defoamer. Observer the defoamers' effect on foam, then put lid on jar, and shake vigorously again. To compare two different defoamers, two jars are used and attached together with tape so that each liquid is exposed to the same vigorous shaking. This method was used to determine effective range of formulation. It was observed that the soap solution by itself was not as effective as the emulsion defoamer. The non-polar oils were not as effective as the emulsion defoamer. For this liquid one of the most effective defoamer contained 15 to 40 percent ammonium stearate and biodiesel or diesel or mineral oil or vegetable oil. Decreasing the water percentage increases the cost without observed benefit. There may be benefit of higher solids in other defoamer application or diluting before use with water.

The selection of which hydrophobic oil, hydrocarbon oil or non-polar hydrocarbon used in defoamer emulsion depends on what other properties are important. For example: Vegetable oils and bio-diesel produce less water resistance than kerosene, paraffin oil and paraffin wax. The soaps once reacted with the previously listed ions prevent this new defoamer made with bio-diesel and vegetable oil from destroying water resistance even when used in excess. To improve water resistance of a pulp or fiberboard product, Kerosene or petroleum diesel is better than vegetable oil or bio-diesel. If VOC emissions are important then canola oil is better than corn oil, Bio-diesel is better than petroleum diesel, Paraffin oil or wax is better than petroleum diesel. Emulsions made with paraffin oil or wax can improve water resistance of a pulp or manufactured board product, while having an impact on reducing foam. If food grade is important then food grade components must be used. Suitable food grade applications include pulp, paper and food or food processes that contain aluminum sulfate (alum) like some pickles. Waste water which contains enough of the ions needed to produce insoluble organometallic solids could also benefit from this new defoamer.

Exemplary methods to make the defoamer are as follows:

### Method A

Add fatty acid to water heated above the melt point of the Fatty Acids or add Fatty acid to water and heat until Fatty acid melts. Mix and add base containing Ammonia, Sodium, or Potassium, forming soap solution with a pH of at least 9. To this soap solution, add a non-polar solvent, oil, or other non-polar hydrocarbon and homogenize the solution to form a stable emulsion.

### Method B

Add fatty acid soap containing ammonia, potassium, or sodium to water and mix while ensuring that the pH is at least 9. To this soap solution then add non polar liquid and homogenize or reduce particle size enough to prevent separation forming a stable emulsion.

### Method C

Add all ingredients to mix tank and homogenize.

The following non-limiting Examples are provided which reflect embodiments of the invention (with all percentages being given by weight %):

### Example 1

Water 5-95%
Stearate soap selected from Ammonium Stearate, Potassium Stearate or Sodium
Stearate or combinations thereof: 0.2-20%
Biodiesel or methyl ester 2-90%

### Example 2

Water 5-95%
Stearate soap selected from Ammonium Stearate, Potassium Stearate or Sodium
Stearate or combinations thereof, 0.2-20%
Non Polar Hydrocarbon 2-90%

### Example 3

Water
Stearate soap selected from Ammonium Stearate, Potassium Stearate or Sodium Stearate
Non polar hydrocarbon selected from Kerosene, diesel, mineral spirits, mineral oil and other liquid non polar solvents or fuels and combinations thereof.

### Example 4

Water
Ammonia, potassium, or sodium fatty acid soap
Liquid non polar hydrocarbon

### Example 5

Water
Ammonia, potassium, or sodium fatty acid soap
Non polar hydrocarbon selected from Kerosene, diesel, mineral spirits, or mineral oil

### Example 6

Water
Ammonia, potassium, or sodium fatty acid soap
Non polar hydrocarbon selected from corn, palm, peanut, canola or other vegetable oil

### Example 7

Bio diesel or Methyl Ester 55-100%
Water insoluble hydrophobic solid like Aluminum, Calcium, Magnesium or Zinc
Stearate 0-45%
Viscosity modifier as needed

### Example 8

Emulsion Composition
Water 5-95%
Fatty Acid 0.4%-20%
Base selected from ammonia,
or solutions of ammonia, or hydroxide of sodium
or potassium, or combinations thereof 0.02-5%
Hydrophobic oil, hydrocarbon oil or hydrophobic wax 2-90%

### Example 9

Emulsion Composition
Water 5-95%
Stearic Acid 0.4%-20%
Ammonia 0.02-5%
Hydrocarbon oil selected from the group consisting of bio diesel, diesel, Kerosene, mineral spirits, mineral oil, vegetable oil or fat, and combinations thereof: 90%

### Example 10

Water resistant additive and method for improved water resistance in manufactured board or wood products. Method includes manufacturing emulsion and applying to wood or to process to achieve improved water resistance and in some cases less foam.
Water 30-85%
Stearic Acid or other Fatty Acid which makes a stable emulsion 0.2%-15%
Ammonia As required to make soap 0.02-4%
Paraffin Wax or oil or combinations thereof 14-69%

### Example 11

An emulsion composition comprising
Water 3 0-80%
Stearic Acid 0.4%-10%
Ammonia 0.02-5%
Bio Diesel 8-69%

What is claimed is:

1. A method of reducing foam or water absorption properties of a final product produced by wet processing during manufacture of said final product, said manufactured final product selected from the group consisting of manufactured board, paperboard, and other cellulose or wood-based products, wherein said wet processing is conducted using processing water that includes hardness ions, said method comprising:
providing an emulsion composition comprising a fatty acid soap and emulsifiers that undergo an exchange reaction with the hardness ions used in the wet processing; and
adding said emulsion composition to the processing water used in said wet processing in a manner so as to distribute said emulsion composition into said processing water so as to allow emulsifiers in said emulsion composition to react with said hardness ions in the processing water in order to form hydrophobic particles and thus change the emulsifiers into a water-resistant compound incorporated into said manufactured final product while also suppressing or eliminating foam in the processing water,
wherein said method is carried out without addition of hydrophobic insoluble particles, and wherein said hydrophobic insoluble particles are formed by the fatty acid soap reacting with said hardness ions; and
wherein said emulsifiers are free of emulsions that interfere with said exchange reaction or cause a decrease in water resistance.

2. The method according to claim 1 further comprising drying said processed manufactured final product so as to obtain a water-resistant manufactured final product, wherein said manufactured final product absorbs less water when submerged in water.

3. The method according to claim 1 wherein said hardness ions are selected from the group consisting of magnesium, calcium, aluminum, iron, and zinc ions.

4. The method according to claim 1 wherein the manufactured final product is insulation board or paper.

5. The method according to claim 1 wherein said hardness ions are present in sufficient concentration so that an exchange reaction takes place.

6. A method of making an emulsion comprising:
reacting a fatty acid, or other emulsifiers that undergo an exchange reaction, with ammonia, amines, sodium or potassium hydroxide, or combinations thereof so that said fatty acid or other emulsifiers no longer act as emulsifiers, soaps, or detergents when added to a wet process containing hardness ions and used in processing of manufactured board, paperboard or other cellulose or wood based product.
adding a hydrophobic oil, a hydrocarbon oil, or a hydrophobic hydrocarbon wax to said fatty acid or other emulsifiers and homogenizing until an emulsion is formed.

7. The method of making an emulsion according to claim 6, wherein the hydrocarbon oil is a non-polar hydrocarbon oil.

8. The method of making an emulsion according to claim 6, wherein the hydrophobic oil is a hydrophobic hydrocarbon oil.

9. The method of making an emulsion according to claim 6, further comprising:
adding said emulsion to a wet process containing hardness ions and used in processing of manufactured board, paperboard or other cellulose or wood based product; and
drying a product obtained by said wet process to obtain a finished product with greater water resistance.

10. The method of making an emulsion according to claim 9, wherein the finished product is insulation board or paper.

11. The method of making an emulsion according to claim 6, wherein the fatty acid is selected from the group consisting of stearic acid, caprylic acid, capric acid, lauric acid, myristic acid, palmitic acid, arachidic acid, behenic acid, lignoceric acid, cerotic acid, palmitoleic acid, sepienic acid, oleic acid, elaidic acid, vaccennic acid, linoleic acid, linolaidic acid, arachidonic acid, eicosapentaenoic acid, erucic acid, docosahexexaenoic acid, tall oil and mixtures thereof.

12. A method of improving water resistance in a finished product obtained by processing of manufactured board, paperboard or other cellulose or wood-based product using a wet process, said method comprising:
providing an emulsion with a water-soluble soap that undergoes an exchange reaction in processing water of said wet process with a hardness ion of calcium, magnesium, iron, aluminum, or zinc and thereby no longer acts as soap;
dispersing said water-soluble soap in said processing water and homogenizing the soap and said processing water with a material selected from the group consisting of hydrophobic hydrocarbon wax, slack wax, paraffin wax, paraffin oil, hydrocarbon oil, and hydrophobic hydrocarbon oil;
adding said emulsion to said processing water to distribute emulsion into the wet process so as to allow soap in said emulsion to undergo an exchange reaction with hardness ions in the processing water so as to form hydrophobic particles or compounds and thereby change said soap into a water resistant compound in said processing water; and
drying or pressing the manufactured board, paperboard, or other cellulose or wood-based product obtained in said method so as to improve water resistance.

13. The method according to claim 12 wherein said method also suppresses, reduces, or eliminates foam in the processing water.

14. The method according to claim 12 wherein said hardness ion is present in sufficient concentration so that an exchange reaction to take place.

15. The method according to claim 12 wherein the pH of the emulsion is between 6 and 9.

16. The method according to claim 12 wherein the pH of the emulsion is greater than 6.

17. A method of reducing foam in industrial water used it a wet process to obtain manufactured board, paperboard, or other cellulose or wood-based product comprising:
providing an emulsion having emulsifiers or a water-soluble soap that undergoes an exchange reaction with a hardness ion used in the wet process, said wet process containing hardness ions used in processing of manufactured board, paperboard or other cellulose or wood based product, said exchange reaction forming a water-soluble salt and an insoluble organometallic solid which acts as a defoamer;
adding said emulsion to industrial water used in said wet process in a manner so as to distribute said emulsion into said wet process so as to allow emulsifiers in said emulsion to react with said hardness ions in the processing water so as to form hydrophobic particles and thus change the emulsifiers into a water resistant compound while also suppressing or eliminating foam in the industrial water during said wet process.

18. The method of claim 17 wherein the hardness ion is selected from the group consisting of calcium, magnesium, iron, aluminum, and zinc.

19. The method of claim 17 wherein said method results in the reduction of water absorption of a product produced by the wet processing of manufactured board, paperboard or other cellulose or wood based product.

20. The method of claim 19 wherein said product is insulation board or paper.
